(19) United States
(12) Patent Application Publication
(10) Pub. No.: US 2013/0172527 A1
(43) Pub. Date: Jul. 4, 2013

(54) PROCESS FOR OBTAINIING TALL OIL FROM A SODIUM SESQUISULFATE SOLUTION

(71) Applicant: Jean Paul Redon Canifru, Las Condes (CL)

(72) Inventor: Jean Paul Redon Canifru, Las Condes (CL)

(73) Assignees: CELULOSA ARAUCO Y CONSTITUCION S.A., Las Condes, Santiago (CL); UNIVERSIDAD DE CONCEPCION, Concepcion (CL)

(21) Appl. No.: 13/807,160

(22) PCT Filed: Dec. 14, 2011
(86) PCT No.: PCT/CL11/00079

§ 371 Date: Mar. 14, 2013

(30) Foreign Application Priority Data
Dec. 29, 2010 (CL) 1609-2010

(51) Int. Cl. C11B 3/04

(52) U.S. Cl. CPC C11B 3/04
USPC 530/208

(57) ABSTRACT

The invention relates to a process for producing tall oil by reacting tall oil soap with a sodium sesquisulfate solution. The process includes the following steps: a) Determining the concentration of sodium sesquisulfate; b) Reaction between sodium sesquisulfate solution and tall oil soap; e) Separating tall oil and brine phases.

### STATE OF THE ART

Nowadays, the tall oil production in pulp mills is mainly conditioned by chemicals and the quality of the wood required in the process.

The main chemical in the input to produce tall oil is sulfuric acid, requiring around 200-300 kg per ton of crude oil tall, depending on the quality of the soap, which increases the costs of the process.

Moreover, the wood type has an effect on the tall oil quality, since different woods produce different types of resin acids, fatty acids, unsaponifiable(s), and therefore, different amounts of tall oil. In general, older trees and slower growth trees produce more resin acids.

The process to produce tall oil uses tall oil soap, specifically obtained from the black liquor resulting from the pulping process, which reacts with sulfuric acid under certain time and temperature conditions. This reaction favors the reduction of the pH solution that is close to 12 to a value below 8. At this pH level, the acidified crude tall oil is separated into two streams by a centrifugation process: crude tall oil (lighter phase) and brine (mainly sodium sulphate and lignin containing hydrogen sulfide).

In addition, an important factor that often affects the economics of an industry is the chemicals' price. For these reasons, it is necessary to develop new processes to produce tall oil that would enable to lower the costs associated with the use of chemicals and to obtain a high quality tall oil. Using sulfuric acid as an acidifying agent decreases tall oil quality, but the only practical alternative would be to use boric acid, which is a weak acid, but its costs is high and interferes in the pulping process, for this reason the sulfuric acid is still used.

Soap effective recovery can increase the chemical recovery in Kraft pulp mills. Simultaneously, it has been discovered that the use of low-cost additives as the lignosulfonates, can increase the performance and efficiency of the tall oil plant.

There are other studies indicating that an option to decrease the consumption of H₂SO₄ is to include a soap pre-treatment step, in which this is reacted with carbon dioxide. This is achieved by a reaction, in which carbon dioxide is dissolved in water to form carbonic acid.

The acid reacts with the soap lowering the pH of the mixture, causing a separation in two phases: creamy appearance soap and baking soda in which the components of the black liquor are dissolved. By using this procedure is achieved the replacement up to 30% of the sulphuric acid needed to acidify the tall oil soap.

Moreover, in bleached wood pulp plants is generated chlorine dioxide (ClO₂), which is used in the pulp bleaching process. In the chlorine dioxide generator is produced a secondary stream, of which a solid is mechanically removed that correspond to an acid salt of sodium sesquisulfate (Na₃H(SO₄)₂). This by-product has a pH value close to 1, making its handling complicated at an operational level. For this reason, currently in a pulp mill is considered a residue, which must be neutralized with soda to adjust it to a basic pH and thus, incorporate it into the black liquor before firing it in the recovery boiler, or in some cases it is sent to the effluents for disposal.

### STATE OF THE INDUSTRIAL PROPERTY

A search was conducted in the major patent offices, globally and nationally, the principal document found that relates to the present technology is described below:

US Patent Application 2008/0214796 A1 entitled: “Method”, refers to a method for controlling the balance of sodium and sulphur in a pulp mill, while provides a process for separating the lignin from black liquor. According to what is stated in the application, it is possible to use sodium sesquisulfate from the chlorine dioxide plant as an agent for adjusting the pH of the mixture, in one step of the process. The process steps are as follows: a) precipitation of lignin by acidifying black liquor by using carbon dioxide; (b) suspending the lignin filter cake and adjusting the pH level by adding sulfuric acid or sodium sesquisulfate from the chlorine dioxide plant; (c) filtering the solution obtained in the previous step; and d) pH adjustment. On the other hand, when necessary, it is possible to increase the amount of acid added in the step (b) and thus using it for acidifying the tall oil soap and producing tall oil.

This document does not interfere neither completely reproduces our technology, so the patentability requirements would not be affected.

### DESCRIPTION OF THE INVENTION

The present technology refers to a process and method to produce tall oil from sodium sesquisulfate. This method is mainly based on using a solution of sodium sesquisulfate for acidifying the tall oil soap and produce tall oil. This innovation allows reducing the use of sulfuric acid in tall oil plants, since this chemical could be replaced up to 100% with a solution of sodium sesquisulfate, obtaining a tall oil suitable for use as a fuel.

Because the sodium sesquisulfate is a byproduct, which currently is not used, whose low pH is its principal property, it is necessary to standardize it so it can be used in tall oil plants. This requires preparing a solution of sodium sesquisulfate by adding water and thus carried out the reaction with tall oil soap.

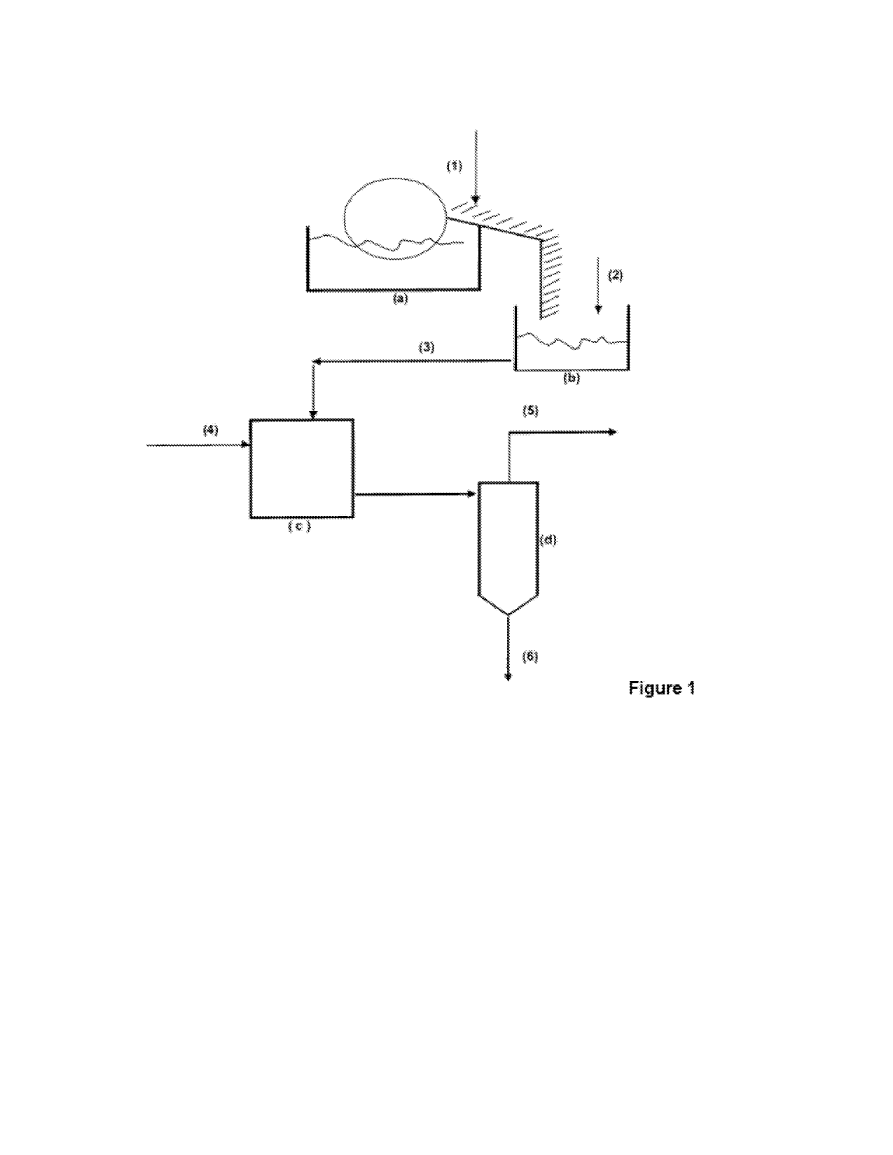

The process comprises the following steps (see FIG. 1):

1. determining of the concentration of the solution of sodium sesquisulfate;

2. reacting sodium sesquisulfate solution with tall oil soap; and

3. separating tall oil and brine phases.

1. Determination of Sodium Sesquisulfate Solution Concentration

To carry out the reaction with tall oil soap, first must be determined the concentration of sodium sesquisulfate solution appropriate for acidifying the soap. To do so, is used acid salt of sodium sesquisulfate (1) coming from the process for producing chlorine dioxide and water (2), and solutions with different concentrations of sodium sesquisulfate are prepared. Later, each solution is submitted to a crystallization test, consisting of lowering the temperature of the solution until reaching the temperature at which it begins to crystallize, which can vary from 20-30° C.

The concentration of the solution at which the acidification of the tall oil soap is carried out ranges from 30 and 50% by weight, preferably from 35% and 45%. At concentrations of lower than 30%, the solution crystallizes at temperatures quite low, therefore it is not operationally feasible. On the other hand, at concentrations greater than 50% by weight of sodium sesquisulfate salt, this is not solubilized. The sodium sesquisulfate solution has a pH level of 1.0-1.4 and the temperature of the solution should preferably be from 40-70° C., before performing the reaction with tall oil soap.

2. Reaction Between Sodium Sesquisulfate Solution and Tall Oil Soap

Once prepared the sodium sesquisulfate solution, it proceeds to carry out the reaction between the tall oil soap at a concentration from 20-70% by weight (4) and the solution of sodium sesquisulfate (3) in a ratio from 30% and 80%, preferably from 50-60% by weight of sodium sesquisulfate solution.

The reaction optimum temperature ranges from 50-200° C., preferably from 90-150° C. The reaction time ranges from 1-30 minutes, preferably from 5-20 minutes. After applying these operating conditions, a yield close to 50% is obtained.

3. Tall Oil and Brine Phases Separation

After the reaction, a solution is obtained that contains two phases: tall oil (5) and brine (6) that comprises sodium sulphate, lignin and calcium sulphate. To achieve a good phase separation, the solution must undergo a centrifugation process at a speed from 1,300 and 1,800 rpm during 1-30 minutes, preferably from 2-20 minutes.

The properties that must be maintained for both tall oil and brine, to ensure a optimum tall oil are: brine pH, which can range from 2.0-5.0, preferably from 3.0-4.0; in the tall oil case the heating value must be from 8,000-10,000 kcal/kg, preferably from 9,000-9,500 kcal/kg and the temperature must range from 50-80° C. to maintain the viscosity; under these conditions the formation of ashes is prevented, which ensures a good separation of the phases after centrifugation.

Thus, it is possible obtaining tall oil from a by-product generated in the process of production of chlorine dioxide, which allows producing tall oil with suitable properties to be used as a fuel under certain operating conditions.

### APPLICATION EXAMPLE

The process to produce tall oil from the reaction between sodium sesquisulfate and tall oil soap is described below:

### a) Determination of the Concentration of Sodium Sesquisulfate Solution

We proceeded to carry out a test of crystallization in sodium sesquisulfate solutions at different percentages by weight from 30 to 40%. Table N° 1 shows the results obtained.

TABLE N^{O} 1
Determination of the concentration of sodium sesquisulfate solution

| Sodium sesquisulfate % w/w | T_{Crystallization} |
|---|---|
| (g salt/g solution) | (° C.) |
| 30 | 23 |
| 35 | 23 |
| 39 | 24 |
| 40 | 23 |

The highest temperature of crystallization was obtained for a sodium sesquisulfate solution concentration of 39%; therefore, at this concentration the reaction for obtaining tall oil was carried out.

### b) Reaction Between Sodium Sesquisulfate Solution and Tall Oil Soap

Once the concentration of solution was obtained, we proceeded to carry out the reaction with the tall oil soap. For this, were reacted 100 g of tall oil soap with 137 g of sodium sesquisulfate solution at 39%. The operating conditions for this reaction were: reaction temperature of 105° C., residence time 1 minute.

### c) Tall Oil and Brine Phases Separation.

Once the reaction has been completed, the product passed through a centrifugation step for 10 minutes and at a centrifugation speed of 1500 rpm. From this step two phases were obtained, tall oil and brine. Table N° 2 shows the most important results of the test.

TABLE N^{O} 2
Tall oil soap acidification with sodium sesquisulfate solution

| | | | Heating | | |
|---|---|---|---|---|---|
| | Weight | | Value | Ashes | Humidity |
| Reactants/Products | (g) | pH | (kcal/kg) | (%) | (%) |
| Tall oil soap | 100 | 11.4 | 0 | 11 | — |
| Sodium sesquisulfate | 137 | 1.4 | — | — | — |
| solution at 39% | | | | | |
| Tall oil | 52 | 4.1 | 9,280 | 0 | 3.7 |
| Brine | — | 3.5 | — | — | — |

The heating value of tall oil obtained by reacting soap with sodium sesquisulfate solution indicates that it is a good fuel. The percentage of ashes of the tall oil sample was 0%, indicating a good separation of tall oil and brine phases during centrifugation.

From the above results, it is feasible to obtain tall oil from the tall oil soap acidification with a sodium sesquisulfate solution, generating a tall oil suitable to be used as a fuel.

1. A process for obtaining tall oil useful as a fuel, comprising the following steps:
a) determining the concentration of sodium sesquisulfate solution;
b) reaction between sodium sesquisulfate solution and tall oil soap; and
e) separating tall oil and brine phases.

2. A process for obtaining tall oil useful as a fuel, according to claim 1, wherein in step (a) the concentration of sodium sesquisulfate solution must be from 30-50%, preferably from 35-45% by weight and at pH level from 1.0-1.4, with a temperature, preferably from 40-70° C.

3. A process for obtaining tall oil useful as a fuel, according to claim 1, wherein in step (b) the sodium sesquisulfate solution reacts in a ratio from 30-80% by weight, preferably from 50-60% by weight with tall oil soap from 20-70% by weight, at a temperature from 50-200° C., preferably from 90-120° C., during 1-30 min, preferably from 5-20 min.

4. A process for obtaining tall oil useful as a fuel, according to claim 1, wherein in step (c) tall oil and brine separation is obtained, the latter consisting of sodium sulphate, lignin and calcium sulphate and with a pH level from 2-5.

5. A process for obtaining tall oil useful as a fuel, according to claim 1, wherein for separating the tall oil and brine, the solution must be centrifuged during 1-30 min, preferably from 2-20 min at a speed from 1,300 and 1,800 rpm.
